(19) United States
(12) Patent Application Publication
(10) Pub. No.: US 2013/0095991 A1
(43) Pub. Date: Apr. 18, 2013

(54) SHEET FOLDER

(71) Applicants: Takeshi ISHIDA, Toyohashi-shi (JP); Kiyohito TSUJIHARA, Toyokawa-shi (JP); Takatoshi HAMADA, Toyokawa-shi (JP); Hiroaki TAKATSU, Nishio-shi (JP); Yohei YAMADA, Toyokawa-shi (JP); Akimasa ISHIKAWA, Toyokawa-shi (JP)

(72) Inventors: Takeshi ISHIDA, Toyohashi-shi (JP); Kiyohito TSUJIHARA, Toyokawa-shi (JP); Takatoshi HAMADA, Toyokawa-shi (JP); Hiroaki TAKATSU, Nishio-shi (JP); Yohei YAMADA, Toyokawa-shi (JP); Akimasa ISHIKAWA, Toyokawa-shi (JP)

(73) Assignee: KONICA MINOLTA BUSINESS TECHNOLOGIES, INC, Tokyo (JP)

(21) Appl. No.: 13/652,556

(22) Filed: Oct. 16, 2012

(30) Foreign Application Priority Data
Oct. 18, 2011 (JP) 2011-228861

(51) Int. Cl. B31F 7/00

(52) U.S. Cl. 493/444

(57) ABSTRACT

A sheet folder includes a blade for bending a sheet, a pair of folding rollers for sandwiching the sheet bent by the blade, a heating unit for heating a folded part of the sheet sandwiched between the pair of folding rollers by the blade, a temperature detection unit for detecting a temperature of the folded part, and a control unit for keeping a state in which the sheet is sandwiched between the pair of folding rollers until at least one of a temperature change and a temperature of the folded part that are detected by the temperature detection unit satisfies a prescribed condition after the blade allows the sheet to be sandwiched between the pair of folding rollers.

This application is based on Japanese Patent Application No. 2011-228861 filed with the Japan Patent Office on Oct. 18, 2011, the entire content of which is hereby incorporated by reference.

### BACKGROUND OF THE INVENTION

1. Field of the Invention

The present invention relates to a sheet folder provided in a post-processing apparatus employed in an image forming system.

2. Description of the Related Art

In a post-processing apparatus having a sheet folder including a folding roller pair for folding a stack of sheets, the degree of folding (folding quality) of the folded sheets is reduced as the number of sheets increases, and the sheets are opened again.

In order to solve such a problem, a technique for improving the degree of folding by humidifying and/or heating a folded part of sheets is disclosed.

For example, Japanese Laid-Open Patent Publication No. 2007-084324 discloses a method for preventing cracks or removal of toner images by heating a folded part when folding sheets. Japanese Laid-Open Patent Publication No. 2008-230814 discloses a configuration using humidifying and heating means for reinforcing a fold.

However, with only the provision of humidifying means and/or heating means, it is difficult to humidify and/or heat sheets optimally in accordance with variations in number and thickness of sheets.

For example, a folding roller pair having heating means for applying heat at a predetermined temperature can sufficiently heat a stack of thin sheets including a small number of sheets but cannot sufficiently heat a stack of thick sheets including a large number of sheets. Otherwise, a stack of thin sheets including a small number of sheets are heated excessively with the settings for sufficiently heating a stack of thick sheets including a large number of sheets.

Moreover, Japanese Laid-Open Patent Publication No. 2007-084324 above is not directed to a technique for improving the degree of folding. Japanese Laid-Open Patent Publication No. 2008-230814 does not disclose a configuration for optimal heating depending on a stack of sheets. Therefore, the problem above cannot be solved by using those related arts.

In order to alleviate the effects brought about by the problem above, information such as the type of sheet (thickness) and the number of sheets in a stack may be used to control the heater temperature of the heating means or the folding speed. However, with only such information, it is difficult to properly maintain the degree of folding (folding quality) of a stack of folded sheets due to environmental factors or variations in a stack of sheets.

### SUMMARY OF THE INVENTION

The present invention is directed to provision of a sheet folder capable of properly maintaining the degree of folding (folding quality) when sheet is creased.

According to an aspect of the present invention, a sheet folder for creasing a sheet is provided. The sheet folder includes a blade for bending the sheet, a pair of folding rollers for sandwiching the sheet bent by the blade, a heating unit for heating a folded part of the sheet sandwiched between the pair of folding rollers by the blade, a temperature detection unit for detecting a temperature of the folded part, and a control unit for keeping a state in which the sheet is sandwiched between the pair of folding rollers until at least one of a temperature change and a temperature of the folded part that are detected by the temperature detection unit satisfies a prescribed condition after the blade allows the sheet to be sandwiched between the pair of folding rollers.

Preferably, the heating unit is contained in one of the pair of folding rollers, and the temperature detection unit is contained in the other of the pair of folding rollers.

Preferably, the heating unit is arranged in contact with a surface of one of the pair of folding rollers.

Preferably, the heating unit and the temperature detection unit are arranged to face each other with the folded part of the sheet interposed therebetween in a state in which the sheet is sandwiched between the pair of folding rollers.

Preferably, the control unit determines whether a temperature of the folded part reaches a predetermined target temperature, as the prescribed condition. The control unit changes the target temperature based on attribute information of the sheet.

Preferably, the control unit changes a temperature target value of the heating unit based on attribute information of the sheet.

Preferably, the control unit changes electric power for driving the heating unit, based on attribute information of the sheet.

Preferably, the control unit changes a speed at which the blade allows the sheet to be sandwiched between the pair of folding roller, based on attribute information of the sheet.

Preferably, the attribute information of the sheet includes a sheet size, a type, and the number of the sheet.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an apparatus configuration of an image forming system according to an embodiment of the present invention.

FIG. 2 is a schematic diagram showing an apparatus configuration of a post-processing apparatus shown in FIG. 1.

FIG. 3 is a schematic diagram showing an operation of folding sheets by a sheet folder according to the present embodiment.

FIG. 4 is a time chart showing a folding operation in a time series in the sheet folder according to the present embodiment.

FIG. 5 is a block diagram showing an electrical configuration of the post-processing apparatus shown in FIG. 1.

FIG. 6 is a schematic diagram showing a state in which sheets are sandwiched in a nip in the sheet folder according to the present embodiment.

FIG. 7 is a schematic diagram conceptually showing a state in which heat emitted from a heater is transmitted through sheets to a temperature sensor in the sheet folder according to the present embodiment.

FIG. 8 is a diagram showing an example of a temporal change of a value detected by the temperature sensor when sheets S shown in FIG. 6 are sandwiched in the nip.

FIG. 9 is a diagram for explaining a process of changing a target temperature in the sheet folder according to the present embodiment.

FIG. 10 is a flowchart showing a process procedure in connection with the process of folding sheets in the sheet folder according to the present embodiment.

FIG. 11 is a cross-sectional structure diagram showing a main part of the sheet folder according to a modified embodiment of the present invention.

FIG. 12 is a cross-sectional structure diagram showing a main part of the sheet folder according to another modified embodiment of the present invention.

### DESCRIPTION OF THE PREFERRED EMBODIMENTS

A post-processing apparatus having a sheet folder and an image forming system including the post-processing apparatus according to an embodiment of the present invention will be described with reference to the figures. It should be noted that the scope of the present invention is not necessarily limited to the number or quantity mentioned in the following embodiments unless otherwise specified. The same or corresponding parts are denoted with the same reference numerals, and an overlapping description may not be repeated. It is initially intended to combine the configurations in the embodiments as appropriate.

[1. Apparatus Configuration of Image Forming System]

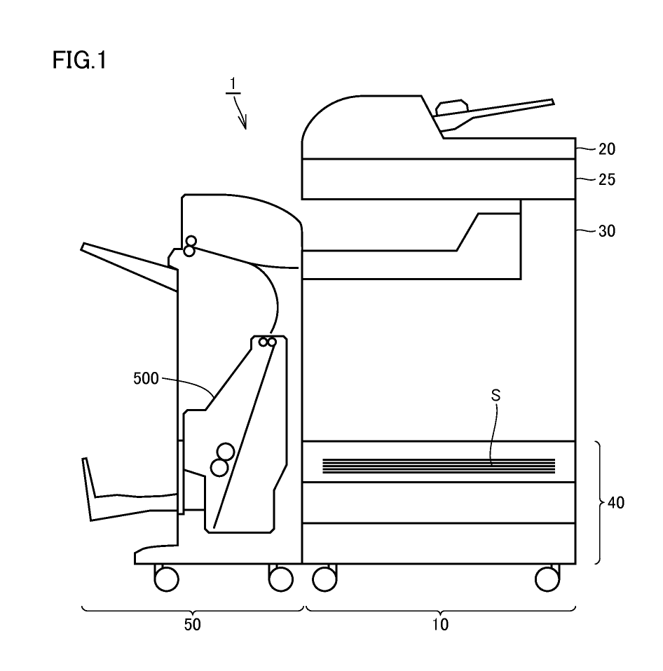

First of all, an apparatus configuration of an image forming system 1 according to an embodiment of the present invention will be described. FIG. 1 is a schematic diagram showing an apparatus configuration of image forming system 1 according to an embodiment of the present invention.

Referring to FIG. 1, image forming system 1 is mainly configured with an image forming apparatus 10 and a post-processing apparatus 50.

Image forming apparatus 10 forms an image on a sheet S as a medium. More specifically, image forming apparatus 10 includes an ADF (Automatic Document Feeder) 20 for automatically performing successive conveyance of originals in a copy or scan operation, a scanner 25 for scanning an original to generate image data, a print engine 30 for forming an image on sheet S based on image data generated by scanner 25 or image data stored in advance, and a paper-feed unit 40 for feeding sheet S on which an image is to be formed by print engine 30.

Post-processing apparatus 50 performs post-processing including a punching process, a stapling process, and a folding process for sheet(s) S having an image formed thereon in image forming apparatus 10. More specifically, post-processing apparatus 50 includes a sheet folder 500 for performing a folding process on sheet(s) S.

[2. Apparatus Configuration of Post-processing Apparatus]

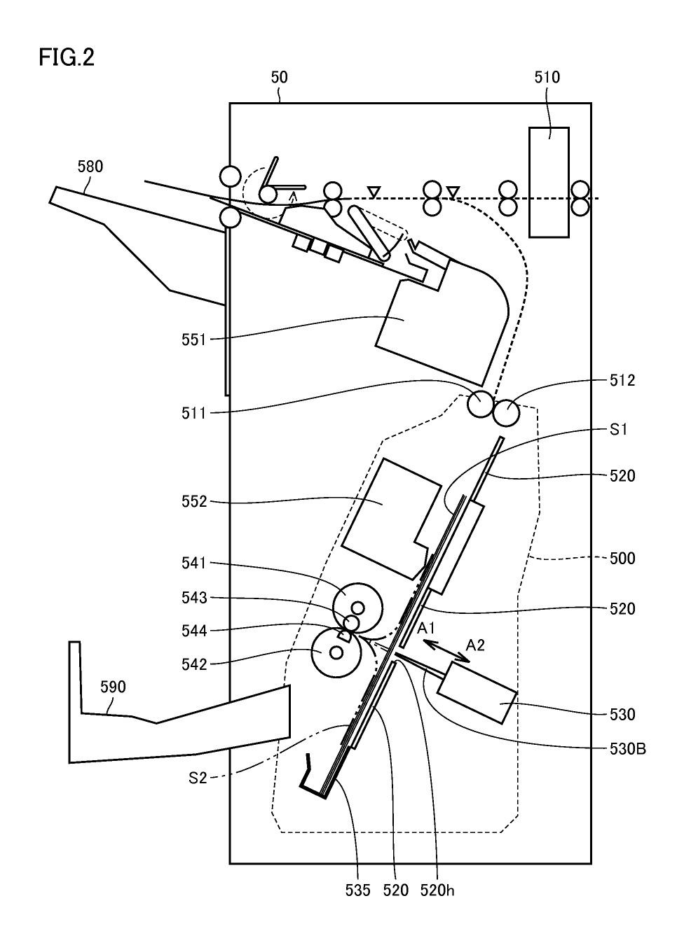

Next, an apparatus configuration of post-processing apparatus 50 included in image forming system 1 according to the present embodiment will be described. FIG. 2 is a schematic diagram showing an apparatus configuration of post-processing apparatus 50 shown in FIG. 1.

Referring to FIG. 2, post-processing apparatus 50 has, in an upper region thereof, a punch unit 510 for performing a punching process on one or more sheets conveyed from image forming apparatus 10, a side-stitching stapler unit 551 for performing a side-stitching process on sheets using a staple, and an output tray 580.

Post-processing apparatus 50 has, in a lower region thereof, a sheet folder 500 for creasing one or more sheets. Sheet folder 500 includes a pair of conveyance rollers 511 and 512 for conveying a sheet to the inside of sheet folder 500, a support plate 520 for supporting sheets from the back side thereof, and a stacker 535 provided at a lower end of support plate 520 for aligning the lower ends of sheets.

Support plate 520 has an opening 520h. A folding blade unit 530 for creasing one or more sheets is provided in opening 520h in a region opposite to the side on which a sheet is conveyed. Folding blade unit 530 has a folding blade 530B passing through opening 520h for bending one or more sheets.

At a position opposing the sheet-conveying side of opening 520h, a pair of a first folding roller 541 and a second folding roller 542 is provided for creasing one or more sheets with folding blade 530B. That is, first folding roller 541 and second folding roller 542 correspond to a pair of folding rollers for sandwiching one ore more sheets bent by folding blade 530B.

A heater 543 for heating one or more sheets in a sandwiched state is provided inside first folding roller 541, by way of example. A temperature sensor 544 is provided in second folding roller 542 to face first folding roller 541. Temperature sensor 544 may be provided at any place as long as it can detect the temperature of a folded part of a sheet or sheets. Preferably, temperature sensor 544 is arranged in the vicinity of heater 543 or in the opposing, folding roller.

In other words, heater 543 corresponds to a heating unit for heating a folded part of sheets sandwiched between a pair of first folding roller 541 and second folding roller 542 by folding blade 530B. Temperature sensor 544 corresponds to a temperature detection unit for detecting the temperature of the folded part of sheets.

The configuration and the arrangement position of heater 543 and temperature sensor 544 can be implemented in multiple fashions as described later and are designed appropriately depending on the configuration or ability of sheet folder 500.

A saddle-stitching stapler unit 552 for performing a saddle-stitching process on sheets using a staple is provided upstream from a pair of first folding roller 541 and second folding roller 542.

A booklet tray 590 is provided at a lower portion of sheet folder 500. A booklet with a fold is output onto booklet tray 590 by a pair of first folding roller 541 and second folding roller 542.

In FIG. 2, pre-creased sheets are shown as sheets S1 in a solid line, and sheets pushed up by folding blade 530B to be creased are shown as sheets S2 in a two-dot chain line, for the sake of explanation.

[3. Folding Operation by Sheet Folder]

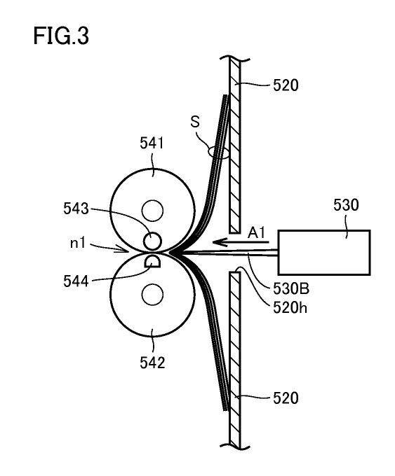

Referring now to FIG. 2 and FIG. 3, an operation of folding sheets S by sheet folder 500 according to the present embodiment will be described. FIG. 3 is a schematic diagram showing an operation of folding sheets by sheet folder 500 according to the present embodiment.

Sheets S conveyed from image forming apparatus 10 are supported along support plate 520 to be conveyed into folding stacker 535. A prescribed number of sheets are stacked in folding stacker 535. Here, folding stacker 535 aligns the end positions of sheets S so that the center positions of sheets S face opening 520h. Then, a plurality of sheets S stacked are saddle-stitched by saddle-stitching stapler unit 552, if necessary. Thereafter, a prescribed number of sheets S (sheet stack) are conveyed to a folding position.

Then, folding blade 530B provided in folding blade unit 530 is pushed toward a pair of first folding roller 541 and second folding roller 542 so as to pass through opening 520h. In connection with this movement of folding blade 530B, sheets S are pushed toward a pair of first folding roller 541 and second folding roller 542. Then, sheets S are sandwiched in a nip n1 between a pair of first folding roller 541 and second folding roller 542. In this way, a prescribed number of sheets S (sheet stack) are fed to nip n1 between a pair of first folding roller 541 and second folding roller 542 by folding blade 530B, so that folding and conveyance of sheets S are simultaneously performed by a pair of first folding roller 541 and second folding roller 542.

Heater 543 provided in the inside of first folding roller 541 heats the fold of sheets S, and a pair of first folding roller 541 and second folding roller 542 sandwich sheets S in a pressured state, whereby a fold is formed on sheets S.

Then, a pair of first folding roller 541 and second folding roller 542 outputs the folded sheets S (booklet) onto booklet tray 590.

In sheet folder 500 according to the present embodiment, when sheets S are fed into nip n1 between a pair of first folding roller 541 and second folding roller 542, the folded part of sheets S is heated by heater 543 contained in first folding roller 541. Thus, the fibers of sheets are softened, so that the degree of folding (folding quality) of the folded part of sheets S can be improved. Here, the temperature of the folded part of sheets S is detected using temperature sensor 544, and the degree of heating (heating time) of the folded part of sheets S by heater 543 is controlled appropriately, thereby ensuring a sufficient degree of folding, irrespective of variations in thickness of sheets S.

More specifically, in sheet folder 500 according to the present embodiment, after folding blade unit 530 allows sheet(s) S to be sandwiched between a pair of first folding roller 541 and second folding roller 542, sheet(s) S are kept sandwiched between a pair of first folding roller 541 and second folding roller 542 until at least one of a temperature change and a temperature of the folded part that are detected by temperature sensor 544 as a temperature detection unit satisfies a prescribed condition.

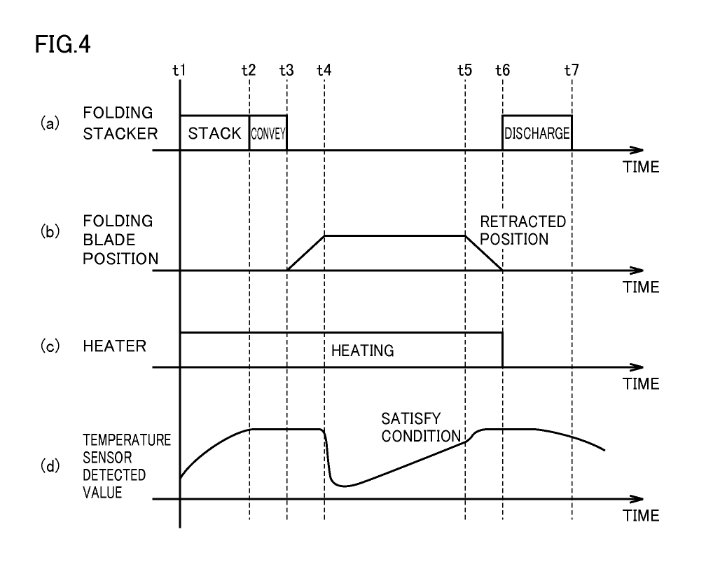

FIG. 4 is a time chart showing a folding operation in a time series in sheet folder 500 according to the present embodiment. In FIG. 4, (a) shows an operational state of folding stacker 535, (b) shows a position of folding blade 530B, (c) shows an operational state of heater 543, and (d) shows a value detected by temperature sensor 544.

Referring to FIG. 4, it is assumed that a folding operation in sheet folder 500 is started at time t1. At time t1, sheet S having an image formed thereon in image forming apparatus 10 at an upstream side starts being conveyed. Folding stacker 535 stacks sheets S until sheets S reach a prescribed number. Thereafter, at time t2 when a designated number of sheets S are stacked, folding stacker 535 conveys a prescribed number of sheets S (sheet stack) to the folding position. Subsequently, folding blade unit 530 starts pushing folding blade 530B (time t3). Then, at time t4, sheets S are sandwiched in nip n1 between a pair of first folding roller 541 and second folding roller 542 (time t4).

On the other hand, heater 543 starts heating at time t1 when an instruction to start the folding operation in sheet folder 500 is given. As a result, heater 543 has been heated sufficiently at time t4 when sheets S are sandwiched in nip n1. As a result, temperature sensor 544 detects a predetermined target temperature.

After sheets S are sandwiched in nip n1, the folded part of sheets S is heated using heat from heater 543, so that the value detected by temperature sensor 544 is decreased. On the other hand, as heating by heater 543 continues, the folded part of sheets S is continuously heated. Then, at time t5, when a prescribed condition (as described later) concerning the value detected by temperature sensor 544 is satisfied, it is determined that the folded part of sheets S is sufficiently heated. Folding blade unit 530 then returns folding blade 530B to the original position (retracted position). When folding blade 530B returns to the retracted position (time t6), folding stacker 535 starts a process of discharging sheets S. More specifically, folding stacker 535 moves upward, so that sheet(s) S is/are discharged by a pair of conveyance rollers 511 and 512.

[4. Electrical Configuration of Post-processing Apparatus]

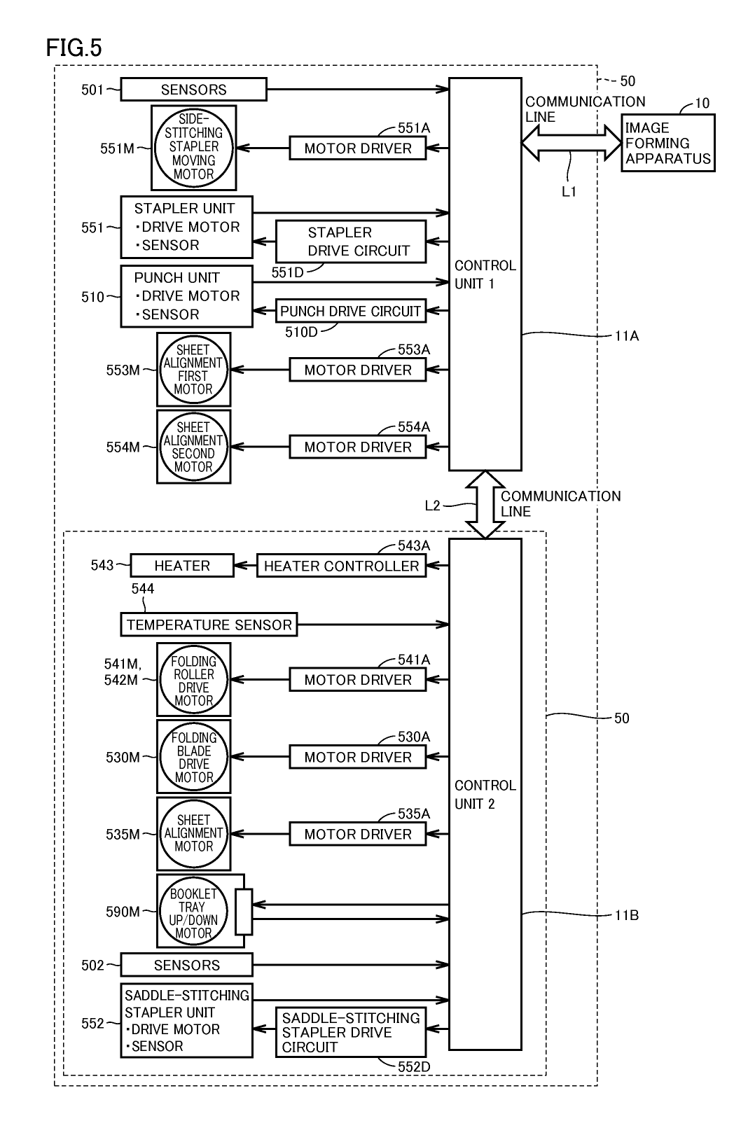

An electrical configuration of post-processing apparatus 50 according to the present embodiment will now be described. FIG. 5 is a block diagram showing an electrical configuration of post-processing apparatus 50 shown in FIG. 1.

Referring to FIG. 5, post-processing apparatus 50 can mutually communicate with image forming apparatus 10 through a communication line L1. In FIG. 5, as a typical implementation, in addition to a control unit for controlling a control operation of post-processing apparatus 50, a control unit for controlling sheet folder 500 is provided. Those control units can communicate with each other through a communication line L2. However, the present invention is not limited to the implementation as shown in FIG. 5 using a plurality of control units connected with each other through a communication line. A single control unit may be used to implement all the processes required in post-processing apparatus 50, or more control units may be used.

A first control unit 11A and a second control unit 11B each mainly include, as essential control elements, a CPU (Central Processing Unit) as an operation unit, a RAM (Random Access Memory) functioning as a working memory, a ROM (Read Only Memory) for storing a program and the like in a nonvolatile manner, and a communication interface.

All or part of control functions of first control unit 11A and/or second control unit 11B may be implemented by software. Alternatively, all or part of first control unit 11A and/or second control unit 11B may be implemented by dedicated hardware.

First control unit 11A controls components included in post-processing apparatus 50 excluding sheet folder 500. More specifically, first control unit 11A controls punch unit 510 and side-stitching stapler unit 551. On the other hand, second control unit 11B mainly controls sheet folder 500. More specifically, second control unit 11B controls sheet folder 500 and saddle-stitching stapler unit 552. In other words, second control unit 11B corresponds to a control unit associated with sheet folder unit 500.

First control unit 11A has control targets including a side-stitching stapler moving motor 551M and a motor driver 551A corresponding thereto, a drive motor/sensor for side-stitching stapler unit 551 and a stapler drive circuit 551D corresponding thereto, a drive motor/sensor for punch unit 510 and a punch drive circuit 510D corresponding thereto, a sheet alignment first motor 553M and a motor driver 553A corresponding thereto, and a sheet alignment second motor 554M and a motor driver 554A corresponding thereto.

First control unit 11A receives sensor information from various sensors 501. First control unit 11A also receives information from the drive motor/sensor for side-stitching stapler unit 551 and the drive motor/sensor for punch unit 510.

Side-stitching stapler moving motor 551M is driven by motor driver 551A controlled in accordance with a command from first control unit 11A.

The drive motor for side-stitching stapler unit 551 is driven by stapler drive circuit 551D controlled in accordance with a command from first control unit 11A. The sensor for side-stitching stapler unit 551 outputs the detected value to first control unit 11A.

The drive motor for punch unit 510 is driven by punch drive circuit 510D controlled in accordance with a command from first control unit 11A. The sensor for punch unit 510 outputs the detected value to first control unit 11A.

Sheet alignment first motor 553M is driven by motor driver 553A controlled in accordance with a command from first control unit 11A. Similarly, sheet alignment second motor 554M is driven by motor driver 554A controlled in accordance with a command from first control unit 11A.

Second control unit 11B has control targets including heater 543, folding roller drive motors 541M and 542M, a folding blade drive motor 530M, a sheet alignment motor 535M, a booklet tray up/down motor 590M, and a drive motor/sensor for saddle-stitching stapler unit 552 and a saddle-stitching stapler drive circuit 552D corresponding thereto.

Second control unit 11B receives sensor information from temperature sensor 544 and various sensors 502. Second control unit 11B also receives information from booklet tray up/down motor 590M and the drive motor/sensor for saddle-stitching stapler unit 552.

Heater 543 is controlled by a heater controller 543A in accordance with a command from second control unit 11B.

Folding roller drive motors 541M and 542M are controlled by a motor driver 541A controlled in accordance with a command from second control unit 11B.

Folding blade drive motor 530M is driven by a motor driver 530A controlled in accordance with a command from second control unit 11B. Sheet alignment motor 535M is controlled by a motor driver 535A controlled in accordance with a command from second control unit 11B.

Booklet tray up/down motor 590M is controlled in accordance with a command from second control unit 11B.

The drive motor for saddle-stitching stapler unit 552 is controlled by saddle-stitching stapler drive circuit 552D controlled in accordance with a command from second control unit 11B.

[5. Folding Process Dependent on Sheet Type]

(5-1) Process Concept

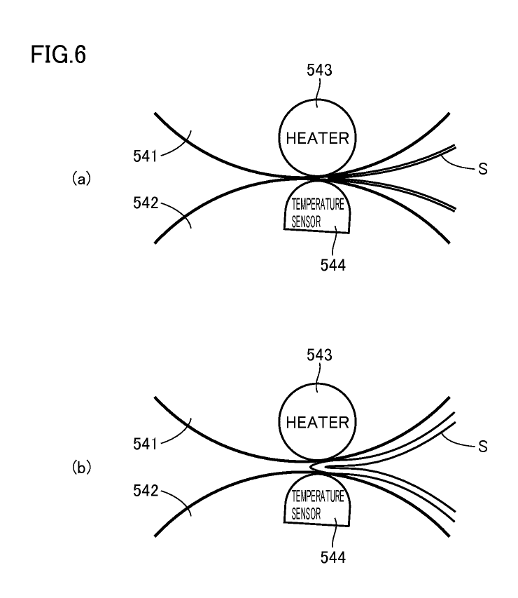

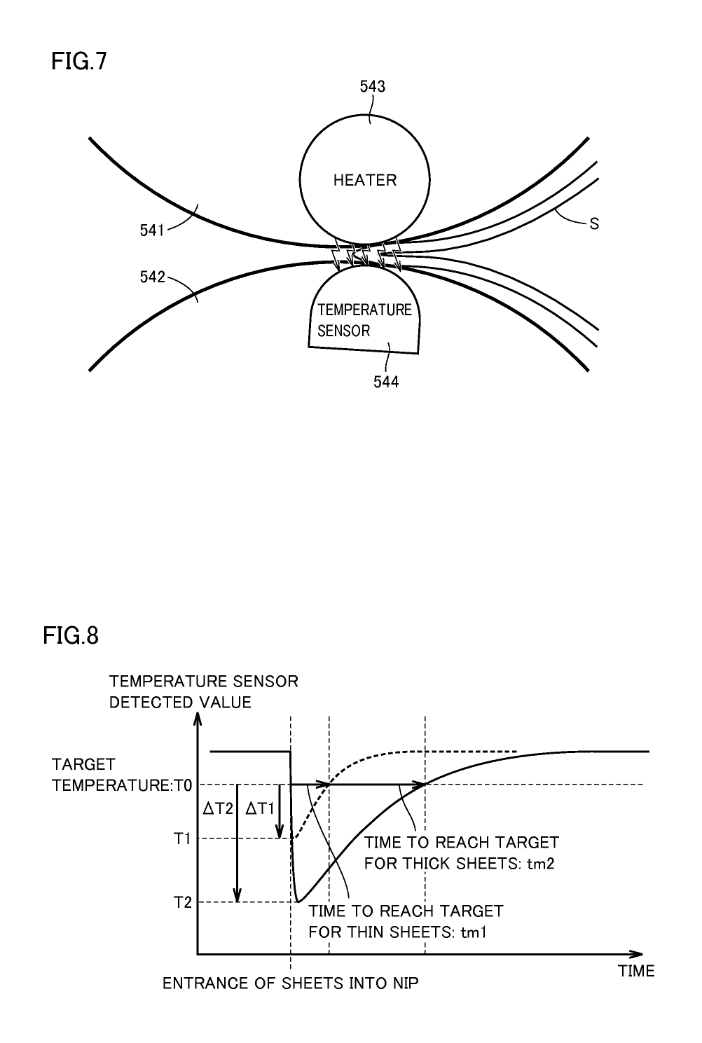

First, referring to FIG. 6 and FIG. 7, the effects by heat and the behavior of the folded part of sheets S in a folding process according to the present embodiment will be described.

FIG. 6 is a schematic diagram showing a state in which sheets S are sandwiched in nip n1 in sheet folder 500 according to the present embodiment. In FIG. 6, (a) shows a state in which relatively thin sheets S (sheet stack) are sandwiched, and (b) shows a state in which relatively thick sheets S (sheet stack) are sandwiched. The arrangement and configuration of heater 543 and temperature sensor 544 as shown in FIG. 6 is shown only by way of example, and any other arrangement and configuration may be adopted as described later. FIG. 7 is a schematic diagram conceptually showing a state in which heat emitted from heater 543 is transmitted through sheets S to temperature sensor 544 in sheet folder 500 according to the present embodiment. FIG. 8 is a diagram showing an example of a temporal change of a value detected by temperature sensor 544 when sheets S shown in FIG. 6 are sandwiched in nip n1.

As shown in FIG. 7, when sheets S (sheet stack) enter nip n1, heat from heater 543 is partially absorbed in the folded part of sheets S. In other words, heat transmission from heater 543 to temperature sensor 544 is cut off, and heat is absorbed in sheets S. As a result, the temperature detected by temperature sensor 544 is reduced.

In FIG. 6, it is assumed that heater 543 is controlled such that the value detected by temperature sensor 544 reaches a target temperature T0 before sheets S enter nip n1. As shown by (a) in FIG. 6, in the case where relatively thin (small thickness) sheets S enter nip n1, the value detected by temperature sensor 544 drops from target temperature T0 to temperature T1 (temperature drop ΔT1). By contrast, as shown by (b) in FIG. 6, in the case where relatively thick (large thickness) sheets S enter nip n1, the value detected by temperatures sensor 544 drops from target temperature T0 to temperature T2 (temperature drop ΔT2).

In other words, when relatively thin sheets S enter nip n1, the magnitude of temperature drop (temperature drop ΔT1) is relatively small, and the subsequent time (time tm1) required for a temperature increase to target temperature T0 is also relatively short. By contrast, when relatively thick sheets S enter nip n1, the magnitude of temperature drop (temperature drop ΔT2) is relatively large, and the subsequent time (time tm2) required for a temperature increase to target temperature T0 is relatively long.

The reason for this is as follows. The larger the thickness of sheets is, the greater the thermal capacity is. Therefore, a drop of the value detected by temperature sensor 544 is greater, and the quantity of heat required for heating sheets S is larger.

Specifically, the quantity of heat (heating time) required for improving the degree of folding (folding quality) of the folded sheets S, which are a target to be creased, can be determined by evaluating a temporal change of the temperature value detected by temperature sensor 544 before and after sheets S enter nip n1. In other words, the quantity of heat (heating time) for achieving a sufficient degree of folding for sheets S varies depending on a difference in attribute values (thickness, number, material) of sheets S (sheet stack). However, even when these attribute values are unknown, the appropriate quantity of heat can be estimated or determined by sensing based on the temperature value detected by temperature sensor 544.

In sheet folder 500 according to the present embodiment, after folding blade unit 530 allows sheets S to be sandwiched between a pair of first folding roller 541 and second folding roller 542, sheets S are kept sandwiched between a pair of first folding roller 541 and second folding roller 542 until at least one of a temperature change and a temperature of the folded part that are detected by temperature sensor 544 as a temperature detection unit satisfies a prescribed condition.

Post-processing apparatus 50 attached to image forming apparatus 10 has sheet folder 500 that is a mechanism for folding a sheet stack. Then, sheet folder 500 includes a pair of first folding roller 541 and second folding roller 542 for folding sheets S, heater 543, and temperature sensor 544. When sheets S are folded into nip n1 between a pair of folding rollers, conveyance is temporarily stopped, and the folded part of sheets S is heated. Here, a temperature change of the folded part is detected by temperature sensor 544. For example, if the detected temperature reaches a prescribed target temperature, it is determined that the folding process is completed, and conveyance of sheets S is resumed. In addition to/instead of evaluation using the absolute value of the detected temperature, the completion of the folding process may be determined based on a temperature change (for example, a rise from the lowest temperature at the time when sheets S enter nip n1) of the folded part that is detected by temperature sensor 544.

Examples of the prescribed condition for a temperature change and a temperature detected by temperature sensor 544 as described above will be shown below.

(5-2) Determination as to Whether Value Detected by Temperature Sensor Reaches Target Temperature

As process logic in a basic folding process, a prescribed condition concerning the completion of the folding process is that the detected value of the temperature detected by temperature sensor 544 after folding of sheets S into nip n1 reaches a predetermined target temperature. Specifically, the control logic of sheet folder 500 includes logic of determining whether the temperature of the folded part of sheets S (the value detected by temperature sensor 544) reaches a predetermined target temperature, as a prescribed condition for determining the timing of completion of the folding process. Then, as shown in FIG. 8, when the value detected by temperature sensor 544 reaches target temperature T0, the folding process for sheets S ends. As shown in FIG. 8, the folded part of sheets S can be heated for an appropriate heating time in accordance with the attribute values (thickness, number, material) of sheets S (sheet stack) by controlling the heating time using the value detected by temperature sensor 544.

(5-3) Setting of Proper Target Temperature

Sheet folder 500 according to the present embodiment aims to improve the degree of folding (folding quality) of sheets S. Essentially, it is also preferable to optimize the target temperature according to the attribute values of target sheets S. In particular, when the sheet stack has a large thickness, the effect of reduction in degree of folding (folding quality) is increased. Then, in order to improve the degree of folding (folding quality) reliably even in such a case, it is also preferable to change the target temperature according to the attribute values of sheets S.

More specifically, the attribute information of sheets S from image forming apparatus 10 arranged upstream is obtained. Then, the target temperature can be changed based on the obtained attribute information. More specifically, the control logic of sheet folder 500 includes logic of determining whether the temperature (the value detected by temperature sensor 544) of the folded part of sheets S reaches a predetermined target temperature, as a prescribed condition for determining a timing of completion of the folding process. Then, the control logic changes the target temperature to be used in this determination logic, based on the attribute information of sheets S that is obtained from image forming apparatus 10.

More specifically, in this determination logic, a further optimum folding process is implemented by switching target temperatures based on the attribute information (media information) of sheets S that is obtained from image forming apparatus 10. The attribute information includes, for example, the sheet size, the type, and the number of sheets S (sheet stack).

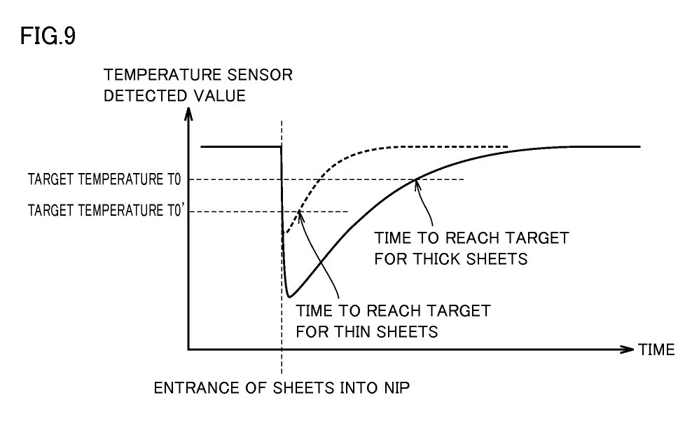

FIG. 9 is a diagram for explaining a process of changing a target temperature in sheet folder 500 according to the present embodiment. In the control logic shown in FIG. 9, the target temperature is set at a lower value (target temperature T0′) for relatively thin sheets S (or a sheet stack including a smaller number of sheets), whereas the target temperature is set at a higher value (target temperature T0) for relatively thick sheets S (or a sheet stack including a larger number of sheets).

By switching the target temperatures in this manner, the folded part can be heated more properly according to the attribute values of sheets S. Switching the target temperatures also shortens the time taken to increase the temperature of sheets S thereby increasing productivity, in a case where the number of sheets to be processed is small, or sheets S are thin.

(5-4) Preliminary Control of Heater Temperature/Quantity of Heat Generated

The thermal capacity greatly varies depending on the thickness of sheets S as described above. Therefore, attribute information indicating the quantity of heat that can be absorbed by the folded part of sheets S is obtained beforehand, so that the temperature of heater 543/the quantity of heat generated can be preliminarily controlled based on the obtained attribute information.

Specifically, when sheets S (sheet stack) are relatively thick, the temperature of heater 543 is changed in advance according to the thickness of the sheets for the purpose of shortening the process time required for the folding process. As a result, the heating time for sheets S can be shortened, thereby increasing productivity.

More specifically, the attribute information of sheets S is obtained from image forming apparatus 10 arranged upstream. Then, the temperature target value of heater 543 is changed based on the obtained attribute information at a stage before sheets S are sandwiched in nip n1. The attribute information includes, for example, the sheet size, type, and number of sheets S (sheet stack).

Basically, heater 543 is controlled such that the value detected by temperature sensor 544 agrees with the set temperature target value. Therefore, heater 543 can be set in a proper state for sheets S in response to a change in temperature target value. In this case, with the temperature target value being changed based on the attribute information of sheets S, electric power for driving heater 543 to be supplied from heater controller 543A is changed.

Electric power for driving heater 543 may be directly controlled even without using the value detected by temperature sensor 544. Electric power for driving heater 543 means the quantity of heat emitted from heater 543 per unit time.

In order for heater 543 to warm up the folding roller, some extent of time is required according to the thermal capacity of the roller. This time may be set properly according to the attribute information of the target sheets S (sheet stack). More specifically, while sheets S are stacked one by one into folding stacker 535, electric power to be supplied to heater 543 is regulated so that heater 543 (the value detected by temperature sensor 544) reaches the target temperature. For example, in a case where the number of sheets S accommodated in folding stacker 535 is relatively large, heater 543 may be heated slowly. This eliminates the need for excessively increasing electric power which is electric energy supplied per unit time.

In this manner, electric power supplied can be optimized depending on the number of sheets S included in the sheet stack, by regulating electric power for driving heater 543 according to the attribute information of sheets S. Whether the number of sheets S included in the sheet stack is large or small, control is performed so that the target temperature suitable for the target sheet stack is finally reached. This allows the use of heater 543 having a smaller thermal capacity, heater controller 543A having a small power supply capacity, and a main power supply with reduced power capacity, thereby achieving cost reduction.

(5-5) Setting of Proper Conveyance Speed/Conveyance Time

The folded part of sheets S may be heated in proximity to heater 543 even before sheets S are sandwiched in nip n1. Therefore, the time for keeping sheets S sandwiched between a pair of first folding roller 541 and second folding roller 542 may be shortened, thereby suppressing reduction in productivity.

For example, sheets S having a large thickness is passed through nip n1 slowly so that the folded part of sheets S is heated during passage through nip n1. Accordingly, the duration in which the folded part of sheets S is stopped in the state in which it is sandwiched in nip n1 is shortened, thereby minimizing reduction in productivity.

In a case where the number of sheets included in the sheet stack is small and the thickness of sheets S is small, it may not be necessary to stop conveyance of sheets S. In such a case, the duration in which sheets S are stopped in the state in which they are sandwiched in nip n1 may be zero. That is, whether to stop conveyance of sheets S may be switched based on the attribute information of sheets S.

More specifically, the attribute information for sheets S is obtained from image forming apparatus 10 arranged upstream. Then, the speed with which folding blade 530B allows sheets S to be sandwiched between a pair of first folding roller 541 and second folding roller 542 is changed based on the obtained attribute information. The attribute information includes, for example, the sheet size, type, and number of sheets S (sheet stack).

[6. Process Procedure]

A process procedure for implementing a process of folding sheets S in sheet folder 500 according to the present embodiment described above will now be described.

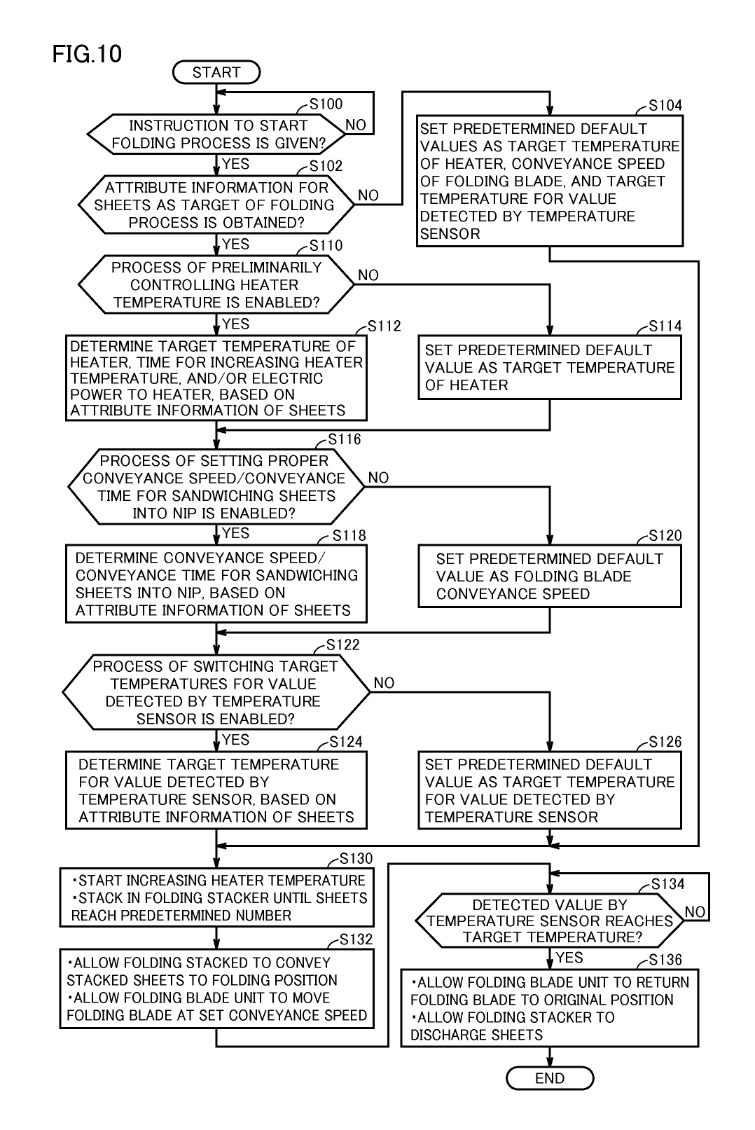

FIG. 10 is a flowchart showing a process procedure in connection with a process of folding sheets S in sheet folder 500 according to the present embodiment. The steps shown in FIG. 10 are basically implemented by second control unit 11B (FIG. 5) executing a program. In the example shown in FIG. 10, all the functions explained in (5-2) to (5-5) above are implemented. However, an implementation in which part of these functions are selectively combined is also envisioned as a matter of course.

Referring to FIG. 10, second control unit 11B determines whether an instruction to start a folding process is given from image forming apparatus 10 (step S100). If an instruction to start a folding process is not given from image forming apparatus 10 (NO in step S100), the process in step S100 is repeated.

If an instruction to start a folding process is given from image forming apparatus 10 (YES in step S100), second control unit 11B accesses image forming apparatus 10 and determines whether the attribute information for sheets S (sheet stack) as a target of the folding process is obtained from image forming apparatus 10 (step S102).

If the attribute information of sheets S (sheet stack) as a target of the folding process fails to be obtained from image forming apparatus 10 (NO in step S102), second control unit 11 B sets a predetermined default value for each of the target temperature of heater 543, the conveyance speed of folding blade 530B, and the target temperature for the value detected by temperature sensor 544 in the state in which sheets S are sandwiched in nip n1 (step S104). The process then proceeds to step 5130.

On the other hand, if the attribute information of sheets S (sheet stack) as a target of the folding process is obtained from image forming apparatus 10 (YES in step S102), second control unit 11 B determines whether the process of preliminarily controlling the temperature of heater 543 is enabled (step S110). Specifically, the process of preliminarily controlling the temperature of heater 543 is enabled when a flag for enabling the preliminary temperature control of heater 543 is set or when heater controller 543A can regulate electric power to be supplied to heater 543, according to the setting information and the like.

If the process of preliminarily controlling the temperature of heater 543 is enabled (YES in step S110), second control unit 11B determines the target temperature of heater 543, the time for increasing the temperature of heater 543, and/or electric power to be supplied to heater 543, based on the attribute information for sheets S that is obtained from image forming apparatus 10 (step S112). The process then proceeds to step S116.

On the other hand, if the process of preliminarily controlling the temperature of heater 543 is not enabled (NO in step S110), second control unit 11B sets a predetermined default value as the target temperature of heater 543 (step S114). The process then proceeds to step S116.

Subsequently, second control unit 11B determines whether the process of setting a proper conveyance speed/conveyance time for allowing sheets S to be sandwiched in nip n1 is enabled (step S116).

If the process of setting a proper conveyance speed/conveyance time for allowing sheets S to be sandwiched in nip n1 is enabled (YES in step S116), second control unit 11B determines the conveyance speed and/or conveyance time for allowing sheets S to be sandwiched in nip n1, based on the attribute information of sheets S that is obtained from image forming apparatus 10 (step S118). The process then proceeds to step S122.

On the other hand, if the process of setting a proper conveyance speed/conveyance time for allowing sheets S to be sandwiched in nip n1 is not enabled (NO in step S116), second control unit 11B sets a predetermined default value as the conveyance speed of folding blade 530B (step S120). The process then proceeds to step S122.

Subsequently, second control unit 11B determines whether the process of switching target temperatures for the value detected by temperature sensor 544 in the state in which sheets S are sandwiched in nip n1 is enabled (step S122).

If the process of switching target temperatures for the value detected by temperature sensor 544 in the state in which sheets S are sandwiched in nip n1 is enabled (YES in step S122), second control unit 11B determines the target temperature for the value detected by temperature sensor 544 in which sheets S are sandwiched in nip n1, based on the attribute information of sheets S that is obtained from image forming apparatus 10 (step S124). The process then proceeds to step S130.

On the other hand, if the process of switching target temperatures for the value detected by temperature sensor 544 in the state in which sheets S are sandwiched in nip n1 is not enabled (NO step S122), second control unit 11B sets a predetermined default value as the target temperature for the value detected by temperature sensor 544 in the state in which sheets S are sandwiched in nip n1 (step S126). The process then proceeds to step S130.

In step S130, second control unit 11B starts increasing the temperature of heater 543 in accordance with the set target temperature and allows sheets S conveyed from image forming apparatus 10 to be stacked in folding stacker 535 until sheets S reach a prescribed number (step S130). In step S112, in a case where the time for increasing the temperature of heater 543 and/or electric power to be supplied to heater 543 is set, second control unit 11B performs control of increasing the temperature of heater 543 in accordance with the set values.

When a prescribed number of sheets S conveyed from image forming apparatus 10 are stacked in folding stacker 535, second control unit 11B instructs folding stacker 535 to convey the stacked sheets S (sheet stack) to the folding position and instructs folding blade unit 530 to move folding blade 530B toward a pair of first folding roller 541 and second folding roller 542 in accordance with the set conveyance speed (step S132).

Subsequently, when sheets S are sandwiched in nip n1, second control unit 11B determines whether the value detected by temperature sensor 544 reaches the target temperature (step S134). If the value detected by temperature sensor 544 does not reach the target temperature (NO in step S134), the process in step S134 is repeated. Specifically, after folding blade 530B allows sheets S to be sandwiched between a pair of first folding roller 541 and second folding roller 542, sheets S are kept sandwiched between a pair of folding rollers until the temperature of the folded part that is detected by temperature sensor 544 satisfies a prescribed condition.

If the value detected by temperature sensor 544 reaches the target temperature (YES in step S134), second control unit 11B instructs folding blade unit 530 to return folding blade 530B to its original position and instructs folding stacker 535 to discharge the creased sheets S (sheet stack) (step S136). The folding process is thus completed.

[7. Configuration of Heating and Temperature Detection]

In sheet folder 500 according to the present embodiment, various configurations can be appropriately adopted for the heating unit for heating the folded part of sheets S sandwiched between a pair of first folding roller 541 and second folding roller 542, and for the temperature detection unit for detecting the temperature of the folded part of sheets S. In the following, a typical configuration and arrangement of the heating unit and the temperature detection unit will be illustrated. The technical scope of the present invention is not limited to those examples, as a matter of course.

(7-1)

As a typical configuration, the configuration as shown in FIG. 3 and FIG. 6 can be employed. Specifically, heater 543 serving as the heating unit is contained in one of a pair of first folding roller 541 and second folding roller 542, and temperature sensor 544 serving as the temperature detection unit is contained in the other roller. Heater 543 and temperature sensor 544 are positioned in contact with sheets S in the state in which sheets S are folded in nip n1 between the folding roller pair. More specifically, heater 543 serving as the heating unit and temperature sensor 544 serving as the temperature detection unit are arranged to face each other with the folded part of sheets S being interposed therebetween in the state in which sheets S are sandwiched between a pair of first folding roller 541 and second folding roller 542.

In this manner, temperature sensor 544 is provided in the other roller that faces the folding roller containing heater 543, whereby the temperature can be sensed with sheets S interposed.

(7-2)

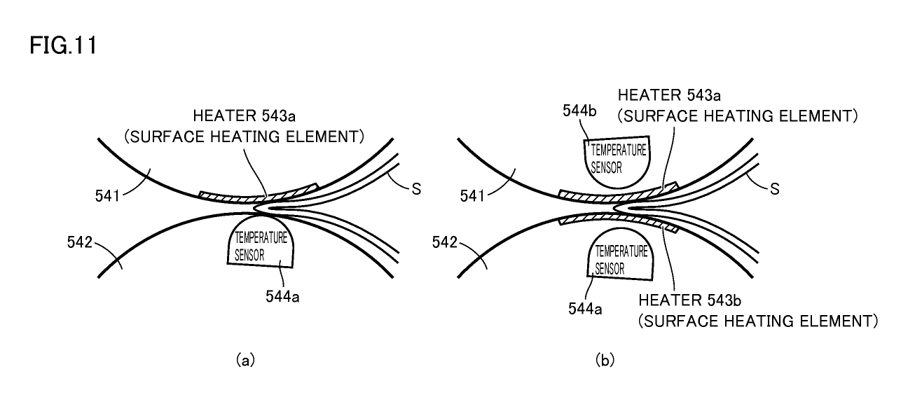

Instead of the configuration above, a surface heating element may be employed. FIG. 11 is a cross-sectional structure diagram showing a main part of the sheet folder according to a modified embodiment of the present invention. In FIG. 11, (a) shows a configuration example in which a pair of the heating unit and the temperature detection unit is arranged, and (b) shows a configuration example in which more than one pairs of the heating unit and the temperature detection unit are arranged.

In a pair of first folding roller 541 and second folding roller 542 shown by (a) in FIG. 11, a heater 543a as the heating unit is arranged in contact with the surface of one folding roller, while temperature sensor 544a as the temperature detection unit is contained in the other folding roller. Heater 543a is a surface heating element capable of heating and increasing the temperature of the folded part of sheets S more efficiently.

In FIG. 11, (b) shows a configuration in which heaters of surface heating elements shown in FIG. 11 are provided in both of the folding rollers. Specifically, heater 543a and heater 543b as heating units are arranged in contact with surfaces of first folding roller 541 and second folding roller 542, respectively. Temperature sensors 544a and 544b are contained in the other folding rollers that face heaters 543a and 543b, respectively. With such a configuration, the folded part of sheets S can be heated/increased in temperature from both of the folding rollers.

With such a configuration, the values detected by temperature sensors 544a and 544b are output. In this case, various control may be performed using these values independently, or various control may be performed by calculating a representative value (average) of these detected values.

(7-3)

The folding roller pair may not have a cylindrical shape having a circular cross section. Sheet folder 500 according to the present embodiment forms a fold in sheets S by sandwiching sheets S in a pressured state. Therefore, any cross-sectional shape may be employed as long as sheets S being sandwiched can be brought into a pressured state. Therefore, a configuration example in which a folding roller has a non-circular cross section will be described.

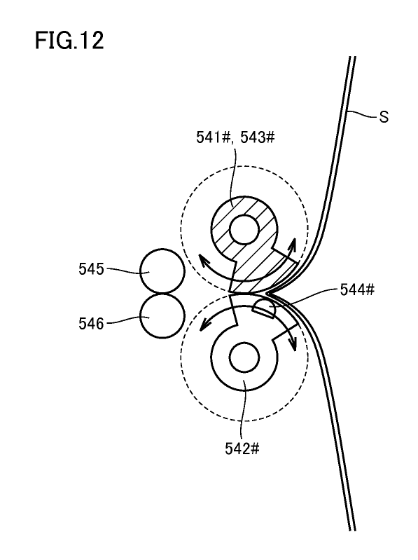

FIG. 12 is a cross-sectional structure diagram showing a main part of the sheet folder according to another modified embodiment of the present invention. Referring to FIG. 12, a pair of a first folding roller 541# and a second folding roller 542# for creasing sheets S each has such a shape in that a pressing member having a sector-shaped cross section is added to the outer circumference of a cylindrical member rotating along an axis of rotation. First folding roller 541# and second folding roller 542# are configured to rotate in synchronization with each other, and the respective pressing members are controlled and configured so as to come into contact with each other with sheets S sandwiched therebetween.

A heater 543# is contained in first folding roller 541# to heat/increase the temperature of first folding roller 541# as a whole. Since first folding roller 541# has a non-circular cross section, the thermal capacity of the folding roller per se can be reduced when compared with the configuration using a cylindrical folding roller as described above. Accordingly, the temperature of the folding roller can be controlled with a shorter response time.

The pressing member of second folding roller 542# contains a temperature sensor 544# for sensing the temperature of the folded part of sheets S. Specifically, heater 543# as the heating unit and temperature sensor 544# as the temperature detection unit are arranged to face each other with the folded part of sheets S interposed therebetween in the state in which sheets S are sandwiched between a pair of first folding roller 541# and second folding roller 542#.

[8. Another Aspect of Present Invention]

The present invention includes a post-processing apparatus according to the following aspect.

A post-processing apparatus according to another aspect of the present invention has a mechanism attached to an image forming apparatus for folding a sheet stack. The mechanism of the post-processing apparatus for folding a sheet stack has a roller pair containing a heater for folding sheets and a temperature sensor. The control logic of the mechanism for folding a sheet stack detects a temperature change of the folded part of sheets with the temperature sensor when conveyance of sheets is temporarily stopped for heating in the state in which the sheets are folded into the nip between the roller pair, and determines that folding is completed when the detected temperature reaches a prescribed temperature, and then resumes conveyance of the sheets.

Preferably, the control logic above stores the attribute information of sheets, such as the size, the type, and the number of sheets, and switches the temperature levels for determining the completion of folding, based on the attribute information.

Preferably, the control logic above switches the heater temperatures based on the attribute information of sheets, such as the sheet size, the type, and the number of sheets.

Preferably, the control logic above switches the conveyance speeds of sheets by the folding rollers, based on the attribute information of sheets, such as the sheet size, the type, and the number of sheets.

Preferably, the control logic above changes electric power to be supplied to the heater, based on the attribute information of sheets, such as the sheet size, the type, and the number of sheets.

[9. Advantages]

According to the embodiments of the present invention, a temperature sensor (temperature detection unit) is provided in the vicinity of a heater (heating unit) associated with a folding roller, or in a folding roller opposing thereto. Then, conveyance is stopped in the state in which sheets (sheet stack) are sandwiched in a nip between a pair of folding rollers, and the folded part of the sheets is heated by the heater. Then, a temperature change is sensed using a temperature sensor. More specifically, the folding quality is ensured by stopping conveyance in the state in which the sheets (sheet stack) are sandwiched in the nip between a pair of folding rollers, and by allowing the temperature detected by the temperature sensor to reach a target temperature.

Accordingly, it is possible to evaluate the state of temperature change of the sheet stack and to make sure that heating is done until the degree of folding sheets (folding quality) is ensured. With such a configuration, a sufficient degree of folding can be achieved without being affected by the size, material and number of sheets and surrounding environments.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A sheet folder for creasing a sheet, comprising:
a blade for bending said sheet;
a pair of folding rollers for sandwiching said sheet bent by said blade;
a heating unit for heating a folded part of said sheet sandwiched between said pair of folding rollers by said blade;
a temperature detection unit for detecting a temperature of said folded part; and
a control unit for keeping a state in which said sheet is sandwiched between said pair of folding rollers until at least one of a temperature change and a temperature of said folded part that are detected by said temperature detection unit satisfies a prescribed condition after said blade allows said sheet to be sandwiched between said pair of folding rollers.

2. The sheet folder according to claim 1, wherein
said heating unit is contained in one of said pair of folding rollers, and
said temperature detection unit is contained in the other of said pair of folding rollers.

3. The sheet folder according to claim 1, wherein said heating unit is arranged in contact with a surface of one of said pair of folding rollers.

4. The sheet folder according to claim 1, wherein said heating unit and said temperature detection unit are arranged to face each other with the folded part of said sheet interposed therebetween in a state in which said sheet is sandwiched between said pair of folding rollers.

5. The sheet folder according to claim 1, wherein
said control unit is configured to determine whether a temperature of said folded part reaches a predetermined target temperature, as said prescribed condition, and
said control unit is configured to change said target temperature based on attribute information of said sheet.

6. The sheet folder according to claim 1, wherein said control unit is configured to change a temperature target value of said heating unit based on attribute information of said sheet.

7. The sheet folder according to claim 1, wherein said control unit is configured to change electric power for driving said heating unit, based on attribute information of said sheet.

8. The sheet folder according to claim 1, wherein said control unit is configured to change a speed at which said blade allows said sheet to be sandwiched between said pair of folding roller, based on attribute information of said sheet.

9. The sheet folder according to claim 5, wherein the attribute information of said sheet includes a sheet size, a type, and the number of said sheet.
